(19) United States
(12) Patent Application Publication
(10) Pub. No.: US 2019/0061835 A1
(43) Pub. Date: Feb. 28, 2019

(54) APPARATUS AND METHODS FOR CONNECTING NODES TO PANELS IN TRANSPORT STRUCTURES

(71) Applicant: DIVERGENT TECHNOLOGIES, INC., Los Angeles, CA (US)

(72) Inventors: Broc William TenHouten, Rancho Palos Verdes, CA (US); Kevin Robert Czinger, Santa Monica, CA (US); Chukwubuikem Marcel Okoli, Los Angeles, CA (US); Jon Paul Gunner, Rancho Palos Verdes Estates, CA (US); David Brian TenHouten, Los Angeles, CA (US); Antonio Bernerd Martinez, El Segundo, CA (US); John Russell Bucknell, El Segundo, CA (US); Muhammad Faizan Zafar, Long Beach, CA (US); Thomas Samuel Bowden, Los Angeles, CA (US); William Bradley Balzer, Santa Monica, CA (US); Stuart Paul Macey, Laguna Niguel, CA (US); Zachary Meyer Omohundro, Hermosa Beach, CA (US); Matthew Michael O'Brien, Hermosa Beach, CA (US)

(21) Appl. No.: 15/687,409

(22) Filed: Aug. 25, 2017

(51) Int. Cl. B62D 27/02; B62D 25/02; B62D 65/06; B33Y 80/00

(52) U.S. Cl. CPC B62D 27/026; B33Y 80/00; B62D 65/06; B62D 25/02

(57) ABSTRACT

Apparatus and methods for joining nodes, extrusions, and panels are presented herein. Nodes, extrusions, and panels can be joined together using adhesive joining techniques. The adhesive joining techniques can be applied to additively manufactured nodes or extrusions, and sandwich panels. Sandwich panels can be additively manufactured and/or commercial off the shelf (COTS) components. There can be more than one type of a joint formed by the joining techniques. Exemplary types of j oints can use a liquid adhesive in conjunction with a vacuum and/or a film foam adhesive.

### FIELD

The present disclosure relates generally to techniques for joining nodes to panels, and more specifically to joining nodes to panels using additively manufactured parts and techniques.

### BACKGROUND

Recently three-dimensional (3D) printing, also referred to as additive manufacturing, has presented new opportunities to efficiently build parts for automobiles and other transport structures such as airplanes, boats, motorcycles, and the like. Applying additive manufacturing processes to industries that produce these products has proven to produce a structurally more efficient transport structure. An automobile produced using 3D printed components can be made stronger, lighter, and consequently, more fuel efficient. Advantageously, 3D printing, as compared to traditional manufacturing processes, does not significantly contribute to the burning of fossil fuels; therefore, the 3D printing of parts for automobiles can be more eco-friendly than conventional manufacturing techniques.

Automobiles and transport vehicles are constructed with panels and extrusions.

Conventional techniques for joining parts, such as welding, may not be a viable alternative for use with additively manufactured panels and extrusions. Accordingly, there is a need to discover and develop new ways to join panels to nodes and/or extrusions using additively manufactured parts and techniques.

### SUMMARY

Several aspects of techniques for joining panels to additively manufactured components, including nodes and/or extrusions, will be described more fully hereinafter with reference to three-dimensional (3D) printing techniques.

In one aspect an apparatus comprises a component, a panel, and an adhesive. The component has a socket; and the panel has an end portion positioned within the socket.

The adhesive is between the end portion of the panel and the socket to adhere the panel to the component.

The panel can be additively manufactured. The component can comprise a channel extending from an external surface of the component to the socket for adhesive injection. The component can further comprise a second channel. The second channel can extend from an external surface of the component to the socket for applying a vacuum during adhesive injection.

The apparatus can comprise a spacer between the end portion of the panel and the socket. The spacer can separate a surface of the panel from a surface of the socket. The surface of the panel can be separated from the surface of the socket so as to reduce galvanic corrosion.

The apparatus can also comprise a sealant between the end portion of the panel and the socket to seal the adhesive in the socket. The sealant can reduce galvanic corrosion by forming a gap. The panel can comprise a plurality of adhesive patches extending across an edge of the end portion of the panel. The adhesive can be between the end portion of the panel and the socket, and the adhesive can extend from the adhesive patches.

Additionally, the component can comprise an additively manufactured node having one or more co-printed heat conductors thermally coupled to the adhesive patches.

The apparatus can further comprise a node. The node can have a second socket at one end and a channel extending from the second socket to an opposite end of the node. The component can comprise an extrusion located in the second socket; and the panel can extend from the socket in the extrusion through the channel in the node.

A first portion of the adhesive can be in the channel between the node and the panel; and a second portion of the adhesive can be in the socket between the extrusion and the panel. Also, a third portion of the adhesive can be in the second socket between the extrusion and the node.

The apparatus can further comprise a plurality of sealants arranged to seal the first, second and third portions of the adhesive from one another. The component can also comprise two nodes adhered together to form the socket. The panel can comprise a hole, and the component can comprise a protrusion extending into the hole of the panel.

The component can comprise an additively manufactured node having one or more co-printed grooves in the socket. Also, the one or more grooves can comprise a first groove and a second groove. The first groove and the second groove can form a channel, and the channel can be configured to from a seal upon receiving an adhesive injection.

The component can comprise an additively manufactured node having a plurality of weep holes for visually monitoring adhesive flow. The component can also comprise an additively manufactured node having a plurality of ports for air expulsion during adhesive injection.

The panel can include one or more thermocouples.

The apparatus can further comprise an additively manufactured modular injector for adhesive injection in a selected region between the component and the panel. The modular injector can further comprise a portion that seals the adhesive between the component and panel in the selected region.

The apparatus can further comprise a punctured encapsulated adhesive tube located on an internal surface of the socket. The adhesive can extend from the punctured tube into the socket. The internal surface of the socket can include a notch; and the punctured encapsulated adhesive tube can be located in the notch.

The panel can comprise a hole; and the component can comprise an additively manufactured node having a co-printed pin extending through the hole.

Also, the apparatus can further comprise a cap having a hole. The distal end of the pin can extend through the hole to secure the panel between the node and the cap.

The component can further comprise an additively manufactured node having one or more grooves formed in the socket; and the adhesive can extend from the one or more grooves into the socket. Also, the end portion of the panel can comprise first and second surfaces. The first and second surfaces can comprise a core region between the first and second surfaces. The one or more grooves can include a groove positioned along the core at an edge of the end portion of the panel. The component can comprise an additively manufactured node having a hole extending from the surface of the node to the socket. The hole can be used to visually monitor adhesive flow. The component can also comprise an additively manufactured node having one or more cups formed in the socket for adhesive or sealant overflow.

In another aspect a method of joining a panel of a transport vehicle comprises obtaining a joining component and adhering the panel to the joining component. The joining component can comprise a node.

Adhering the panel to the joining component can comprise applying a film foam adhesive to an interface of the panel and the joining component. It can also comprise fixturing a joint between the panel and the joining component and increasing the temperature of the adhesive. The temperature can be increased so as to create an adhesive bond.

The joining component can further comprise an extrusion. Also, the panel can be additively manufactured; and the node can be additively manufactured.

Adhering the panel to the joining component can further comprise inserting a spacer between the panel and the joining component. The spacer can form a gap between a surface of the panel and a surface of the joining component. The gap can be formed so as to reduce galvanic corrosion.

Adhering the panel to the joining component can further comprise first applying a sealant so as to secure the panel with the joining component. The sealant can reduce galvanic corrosion by forming a gap. Adhering the panel to the joining component can also comprise injecting an adhesive into an interface of the panel and the joining component.

Injecting the adhesive into an interface of the panel and the joining component can comprise applying an adhesive via an adhesive port; and providing a vacuum via a vacuum port.

The method of joining a panel of a transport vehicle can further comprise monitoring a pressure of the vacuum and withdrawing the vacuum. The pressure can be indicative of the amount of adhesive drawn into the interface; and the vacuum can be withdrawn after the vacuum pressure indicates the adhesive substantially fills the interface.

Applying an adhesive via an adhesive port can occur after providing a vacuum via a vacuum port. Also, applying an adhesive via an adhesive port can occur before providing a vacuum via a vacuum port.

Different complex geometries may be used that were not previously available in traditional manufacturing processes. It will be understood that other aspects ofjoining panels to nodes and/or extrusions will become readily apparent to those skilled in the art from the following detailed description, wherein it is shown and described only several embodiments by way of illustration. As will be appreciated by those skilled in the art, the joining of panels and nodes and/or extrusions using additively manufactured nodes, components, and/or panels can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatus and methods for joining nodes, extrusions, and panels will now be presented in the detailed description by way of example, and not by way of limitation, in the accompanying drawings, wherein:

FIG. 1 illustrates a side perspective view of a panel node joint according to an embodiment.

FIG. 2 illustrates a cross-sectional view of a panel node joint according to an embodiment.

FIG. 3 illustrates a side view of a panel node joint according to another embodiment.

FIG. 4 illustrates a side view of a panel node joint using foam adhesive with thermal stress management according to an embodiment.

FIG. 5 illustrates a cross-sectional view of a node, extrusion, and panel joint using film foam adhesive.

FIG. 6 illustrates a cross-sectional view of a node, extrusion, and panel joint using liquid adhesive.

FIG. 7 illustrates a cross-sectional view of a two-piece node panel joint according to an embodiment.

FIG. 8A illustrates a side perspective view of a panel node joint using a clamp according to an embodiment.

FIG. 8B illustrates a cross section view of the panel node joint of the embodiment of FIG. 8A.

FIG. 8C illustrates a side perspective view of a clamp for use with the embodiment of FIG. 8A.

FIG. 9 illustrates a side perspective view of a panel node joint using a modular injector according to an embodiment.

FIG. 10 illustrates a cross-section view of a panel node joint using adhesive tubes according to an embodiment.

FIG. 11A illustrates a cross-section view of a panel node joint using a film foaming adhesive according to an embodiment.

FIG. 11B illustrates a cross-section view of a panel node joint using a film foaming adhesive according to another embodiment.

FIG. 12 illustrates a cross-section view of a side-mount panel node joint according to an embodiment.

FIG. 13 illustrates a cross-section view of an end-mount panel node joint according to an embodiment.

FIG. 14 conceptually illustrates a process for j oining a panel with ajoining component.

FIG. 15 conceptually illustrates an adhesion process for joining a panel with the joining component according to an embodiment.

FIG. 16 conceptually illustrates an adhesion process for joining a panel with the joining component according to another embodiment.

### DETAILED DESCRIPTION

The detailed description set forth below in connection with the drawings is intended to provide a description of exemplary embodiments of joining nodes, extrusions, and panels using additively manufacturing techniques, and it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of additive manufacturing in the context of joining two or more parts provides significant flexibility and cost saving benefits that enable manufacturers of mechanical structures and mechanized assemblies to manufacture parts with complex geometries at a lower cost to the consumer. The joining techniques described in the foregoing relate to a process for connecting additively manufactured parts and/or commercial off the shelf (COTS) components. Additively manufactured parts are printed three-dimensional (3D) parts that are printed by adding layer upon layer of a material based on a preprogramed design. The parts described in the foregoing may be parts used to assemble a transport structure such as an automobile. However, those skilled in the art will appreciate that the manufactured parts may be used to assemble other complex mechanical products such as vehicles, trucks, trains, motorcycles, boats, aircraft, and the like without departing from the scope of the invention.

Additive manufacturing provides the ability to create complex structures within a part. For example, a part such as a node may be printed with a port that enables the ability to secure two parts by injecting an adhesive rather than welding two parts together, as is traditionally done in manufacturing complex products. Alternatively, some components may be connected using a brazing slurry, a thermoplastic, or a thermoset, any of which can be used interchangeably in place of an adhesive. Thus, while welding techniques may be suitable with respect to certain additive manufacturing embodiments, additive manufacturing provides significant flexibility in enabling the use of alternative or additional connection techniques.

As described above, these are non-traditional approaches to connecting additively manufactured components, such as nodes, extrusions, and/or panels, and it can be advantageous to develop new ways to join components together during the manufacturing process. Joining panels to nodes and/or extrusions may incorporate one or more factors such as materials, structure, design, and/or connecting features.

As discussed above, panels can be COTS parts. Alternatively, panels can be additively manufactured.

Panels may be formed by sheets which in turn may be made of carbon fiber to reduce chassis weight. The sheets may alternatively or additionally be made from metals, such as aluminum, steel, iron, nickel, titanium, copper, brass, silver, or any combination or alloy thereof. Advantages of using metal materials may include improving puncture resistance. Panels may have various structures, such as plain sheets, honeycomb, sandwiched sheets, and the like. The panels may further include internal structures such as honeycomb structures, lattice structures, foam cores, and/or any other suitable 2D or 3D structures as discussed herein. Various structures can avail various advantageous. For instance, panels formed with honeycomb structures can have enhanced strength while using fewer materials. Advantageously, this can reduce weight and cost.

Alternatively, or additionally, panels can be formed as sandwich honeycomb structures. These can be referred to as “sandwich panels.” Also, panels may be formed to contain any suitable internal structures, such as lattice structure described further herein. Panels may include a combination of various internal structures such as honeycomb, foam, or lattice structures. The variety of internal structures may be fabricated using 3D printing (additive manufacturing). In some instances, a panel may be pre-drilled to accelerate riveting to shear panels. Alternatively, adhesives may be applied to the interface of the extrusion and the panel skin to form a connection.

Additionally, additive manufacturing lends itself to node based architectures where components are fixed and/or floating. Floating can refer to being able to move in position for ease of positioning. For instance, a node based architecture enables a panel to be fixed while nodes float during assembly; or enables nodes to be fixed while a panel floats during assembly. When nodes are fixed, the nodes may be tailored to have features which allow a panel to float or move in position so as to facilitate connections to fixtures. Alternatively, when a panels is fixed, the panel may have features that would be connected to a fixture; the nodes would thereby float so as to facilitate assembly with the fixed panel. Following the assembly process of attaching floating/fixed nodes and panels, an adhesive can be injected or added to secure the nodes and panel.

Apparatuses and methods for joining nodes, extrusions, and panels are presented herein. Nodes, extrusions, and panels can be printed and joined together. Adhesive joining techniques can be applied to additively manufactured nodes, extrusions, and sandwich panels. There can be more than one type of a joint formed by the joining techniques. Exemplary types of joints can use a liquid adhesive in conjunction with a vacuum and/or a film foam adhesive.

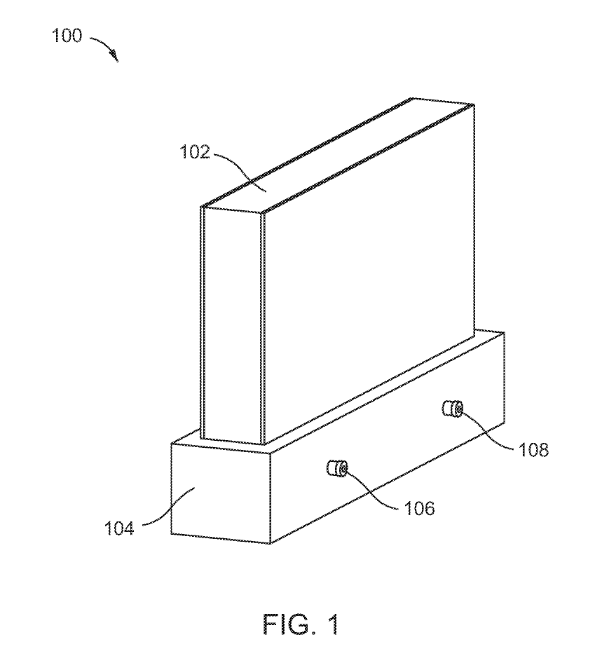

FIG. 1 illustrates a side perspective view of a panel node joint 100 according to an embodiment. A panel 102 is inserted into a node 104 so as to form the panel node joint 100. The panel 102 can be a commercial off the shelf (COTS) panel or it can be an additively manufactured panel as described above. For instance, the panel 102 can be a sandwich panel additively manufactured to have a honeycomb interior. Additionally, the panel node 104 can be additively manufactured. As shown in FIG. 1, the panel node 104 has a port 106 and a port 108. The ports 106 and 108 can be channel ports for receiving a liquid, adhesive, and/or a vacuum. For instance, a vacuum can be applied at port 106 and a liquid adhesive can be applied at port 108. Additionally, and alternatively, as will be described with regards to the following figures, when a liquid adhesive is used, a sealant may also be required. The vacuum may be used to draw the liquid adhesive via channels into an interface formed between the surface of the panel 102 and the inside surface of the node 104.

Although FIG. 1 illustrates a panel node joint 100, the concept of applying a vacuum to draw a liquid adhesive into an interface can also be applied to a panel extrusion joint; and the adhesion techniques discussed herein for panel node joints can also apply to panel extrusion joints.

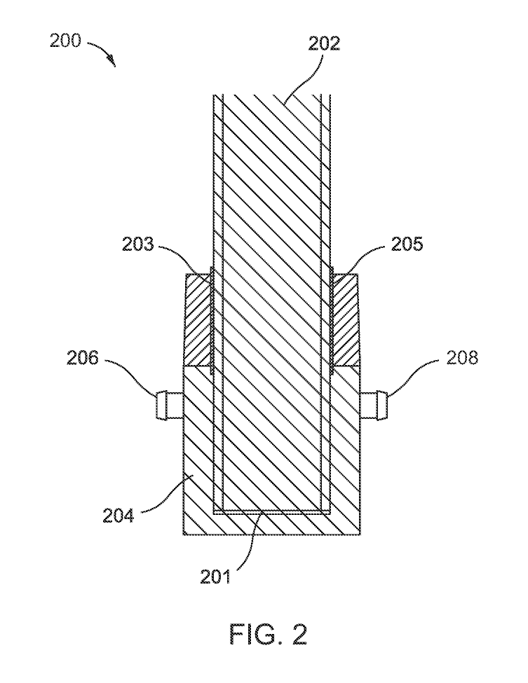

FIG. 2 illustrates a cross-sectional view of a panel node joint 200 according to an embodiment. A panel 202 is inserted into a node 204 so as to form the panel node joint 200. Similar to the panel 102 of FIG. 1, the panel 202 can be a commercial off the shelf (COTS) panel, an additively manufactured panel, and/or a sandwich panel additively manufactured to have a honeycomb interior. As shown in FIG. 2, the panel node 204 has a port 206 and a port 208. The ports 206 and 208 can be used to apply a liquid, adhesive, and/or a vacuum similar to the ports 106 and 108 of FIG. 1. For instance, a vacuum can be applied at port 206 and a liquid adhesive can be applied at port 208 or an alternate adjacent port (not shown) to draw liquid adhesive into an interface 201 formed between the surface of the panel 202 and the inside surface of the node 204. Additionally, a sealant may be applied at the interface 201.

A sealant may also be applied to the panel node joint 200 to seal the interface. For instance, as shown in FIG. 2, sealant may be applied to the interface at a location 203 and at a location 205. The sealant can be applied before a liquid adhesive is drawn into the interface to improve a vacuum created within the interface. Additionally, the interface can be designed to have a gap, or bondline width, conducive to drawing adhesive into the interface. For instance, using additive manufacturing techniques, a node and/or extrusion can be printed so as to meet a bondline width specification of approximately 0.5 millimeters (mm).

In addition to improving the vacuum created within the interface, the sealant can advantageously reduce corrosion between parts by maintaining a gap or space between the parts. For instance, the sealant at interface 201 and locations 203 and 205 can prevent surfaces of the panel 202 from making contact with surfaces of the node 204. Having a separation between parts can reduce or eliminate different types of corrosion including galvanic corrosion which occurs between dissimilar materials. Additionally, sealants can prevent contamination from environmental factors. For instance, the sealants can serve as a physical barrier and block corrosive substances from entering regions between the panel 202 and node 204. Examples of environmental corrosive substances can include road salt, chemicals, and detergents.

After applying sealant to the panel node joint 200, a vacuum can be connected to a port such as port 206 or 208; and an adhesive, applied at another port such as port 206 or 208 can be drawn into the interface by the vacuum. In some embodiments the vacuum may be created before the adhesive is applied, while in other embodiments the adhesive may be applied prior to creating the vacuum. The vacuum pressure can be monitored to determine when the adhesive flow has completely or almost completely filled the interface. Additionally, as one of ordinary skill in the art can appreciate, adhesive volume and mass can be measured to determine if a complete fill has occurred. On completion of the adhesive application, the adhesive can be cured, thereby forming a joint between the two surfaces.

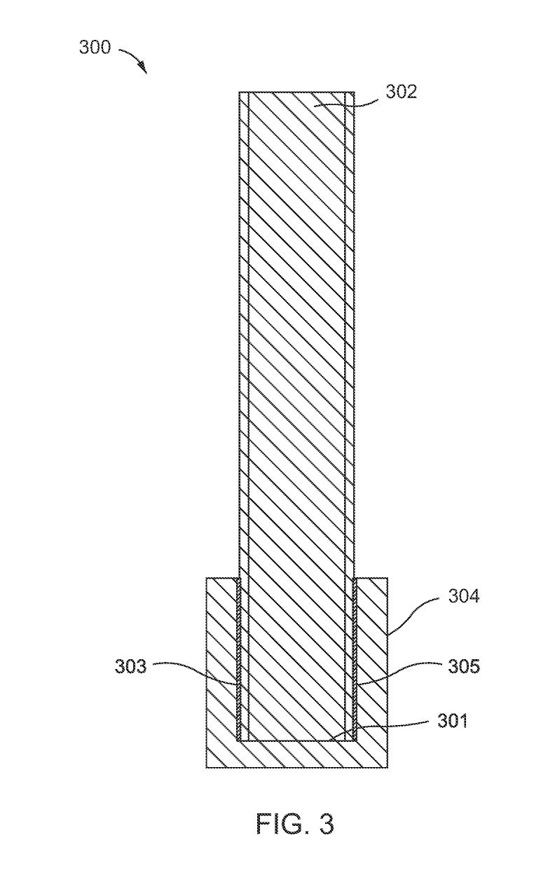

FIG. 3 illustrates a side view of a panel node joint 300 according to another embodiment. As shown in FIG. 3, a panel 302 is inserted into a node 304 so as to form the panel node joint 300. Similar to the panels 102 and 202 of previous FIGS. 1 and 2, the panel 302 can be a commercial off the shelf (COTS) panel, an additively manufactured panel, and/or a sandwich panel additively manufactured to have a honeycomb interior. Also similar to the previous panel node joints 100 and 200 of FIGS. 1 and 2, there is an interface 301 between a surface of the panel 302 and an interior surface of the node 304. The portion of the panel 302 forming part of the interface 301 can be the end portion of the panel 302.

However, unlike the panel node joints 100 and 200 of FIGS. 1 and 2, the panel node joint 300 in this exemplary embodiment can be adhered using a film foam adhesive instead of a liquid adhesive. Using a film foam adhesive can advantageously eliminate complexity associated with liquid adhesive systems so that a sealant would no longer be necessary. A film foam adhesive can be applied to the interface 301 at various locations such as locations 303 and 305. The film foam can be placed in the form of patches. Upon applying the adhesive, the panel 302 and the node 304 can then be fixtured using a fixture or a fixturing device. The fixture can be used to stabilize, support, and hold the panel 302 and the node 304 together prior to a foaming and curing process.

Under elevated temperatures, the adhesive, or adhesive patches, can foam up and cure, forming an adhesive bond at the interface 301. Bonds formed through such processes are typically stronger than liquid adhesive bonds, and less cumbersome. Additionally, the cure time for such adhesives is much lower in comparison with liquid adhesives.

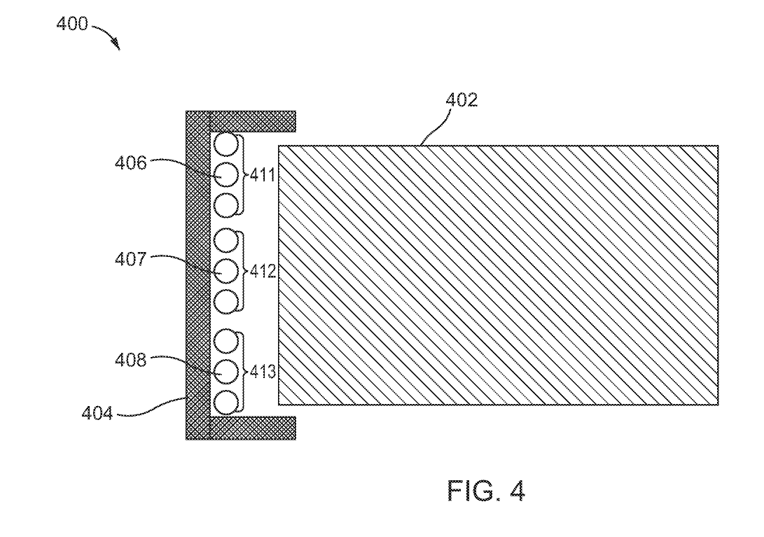

FIG. 4 illustrates a side view of a panel node joint 400 using a foam adhesive with thermal stress management according to an embodiment. A panel 402 is positioned for insertion and fixturing with a component 404. The component 404 can be a node, and/or an extrusion with foam adhesive segments applied to the interface between the panel 402 and the component 404. Additionally, patches of foam adhesive, including patches 406, 407, and 408, can be placed at the interface between the panel 402 and the inside of the component 404.

The panel 402 and the component 404 can have different or dissimilar thermal properties, including thermal expansion properties. A measure of thermal expansion in materials is a coefficient of thermal expansion (CTE) which can have units of inverse temperature. When a coefficient of thermal expansion (CTE) of the panel 402 is different or mismatched from a CTE of the component 404, there can be a thermal stress or loading between the panel 402 and the component 404 during a heating or curing cycle.

A way to mitigate the thermal stresses during the heating cycle is to use temperature groups as illustrated in FIG. 4. As shown in FIG. 4, there are three groups, group 411, group 412, and group 413, of foam adhesive patches. For illustrative purposes, patches 406, 407, and 408 are shown to be positioned within groups 411, 412, and 413, respectively. Thermal stress or loading due to CTE mismatches can be mitigated by heating the groups 411, 412 and 413 at different times and different locations during a curing cycle. For instance, heat could first be applied to the group 411 of patches including patch 406. Subsequently, heat could be applied to the group 413 including patch 408; and finally, heat could be applied to the group 412 including patch 407. In this way, the thermal stresses due to phenomena like CTE mismatches, etc., can be controlled.

Although, FIG. 4 shows one way of mitigating thermal stresses by using three temperature groups, other ways are possible. For instance, fewer or greater than three temperature groups can be selected for applying heat. Additionally, or alternatively, other sequencing techniques can be used during the curing process.

In other embodiments, thermal heat conductors can be placed on a component, such as component 404 of FIG. 4, in order to control heat flow to film foam adhesive patches. For instance, heat conductors can be printed onto a component such as a node, panel, or extrusion during the additive manufacturing process. Printing heat conductors at select locations during the additive manufacturing process can advantageously allow better control and reduction of thermal stresses during a curing step and/or sequence.

In some embodiments, copper (Cu) wires can be co-printed with a component, node, and/or extrusion. Additionally, a heat pad made of iron can be co-printed for transferring heat. This can enable Cu wires to locally transfer heat to a film foam adhesive or adhesive patch directly; and in this way the effects of CTE mismatch between metal nodes and composite panels can be mitigated when the entire assembly is heated.

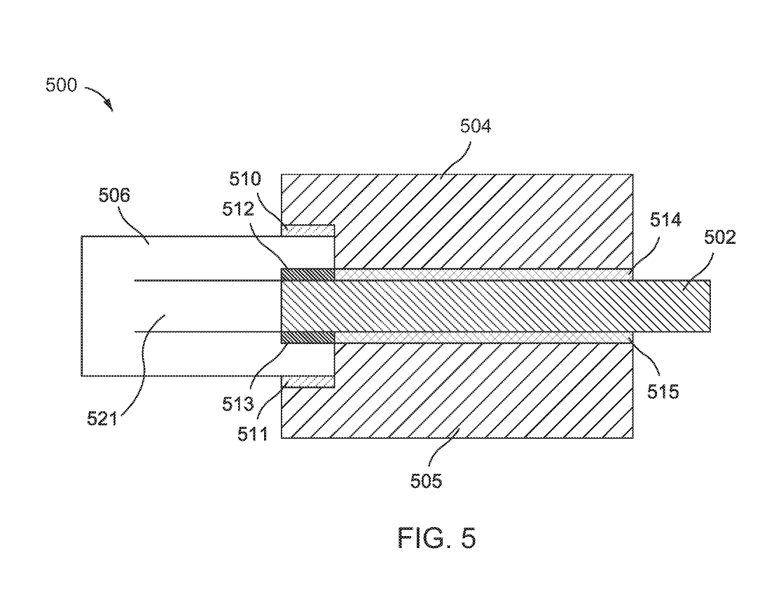

FIG. 5 illustrates a cross-sectional view of a node, extrusion, and panel joint 500 using film foam adhesive. As illustrated, a panel 502 is inserted forming an interface with a node segment 504, a node segment 505, and an extrusion 506. Unlike the previous panel node joints 100, 200, and 300, the joint 500 can have multiple interfaces (joints) for applying adhesive so as to form a more complex joint as compared to the joints 100, 200, and 300 described with reference to FIGS. 1-3, above.

In the embodiment of FIG. 5, the adhesive can be a film foam adhesive applied at interface locations 510, 511, 512, 513, 514, and 515. Film foam adhesive patches applied at interface locations 510 and 511 can form node extrusion joints. Film foam adhesive patches applied at interface locations 512 and 513 can form extrusion panel joints, and film foam adhesive patches applied at interface locations 514 and 515 can form node panel joints.

Steps 517, 519 or other recessed areas can be provided at the end of the node segments 504 and 505 where the extrusion 506 can be inserted. Similarly, the extrusion 506 can have an internal socket 521 or channel to enable fitment of the panel 502. The panel 502 can then be attached to the node segments 504 and 505 via a step-down feature to enable the node-panel attachment at interface locations 514 and 515.

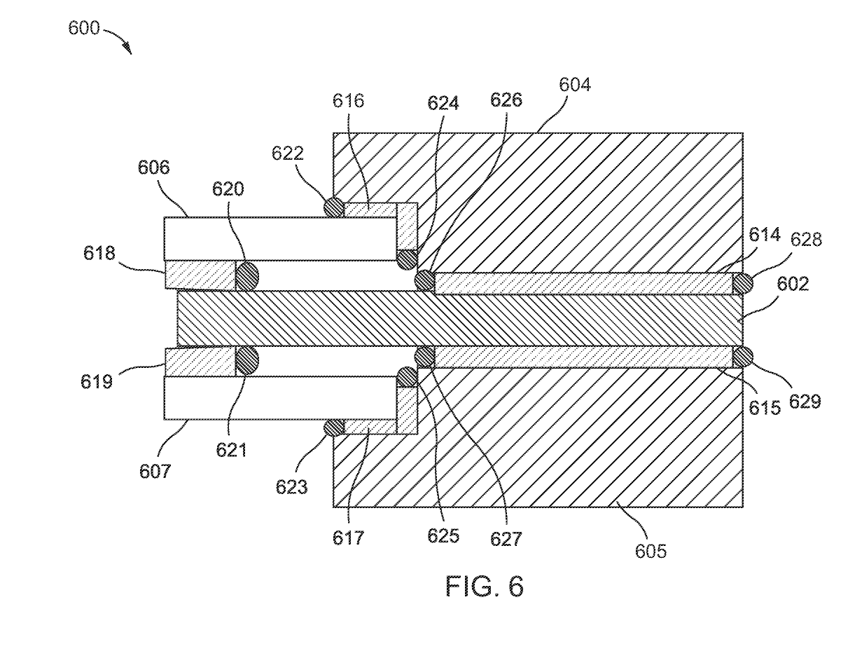

FIG. 6 illustrates a cross-sectional view of a node, extrusion, and panel joint 600 using liquid adhesive. The joint 600 is similar to the joint 500 except it is designed for use with a liquid adhesive process instead of foam adhesive. Like the joint 500 of FIG. 5, the joint 600 has multiple interfaces. For instance, as shown in FIG. 6, there are joints formed between a panel 602, a node segment 604, a node segment 605, an extrusion segment 606, and an extrusion segment 607.

As discussed above with respect to FIG. 2, a liquid adhesive process may require channel ports (not shown) to draw liquid adhesive via channels, connecting to the ports, and using a vacuum. As shown in FIG. 6, sealant can be applied at sealant locations 620-929 so as to allow a liquid adhesive to be drawn into the interfaces by sealed locations 614-619.

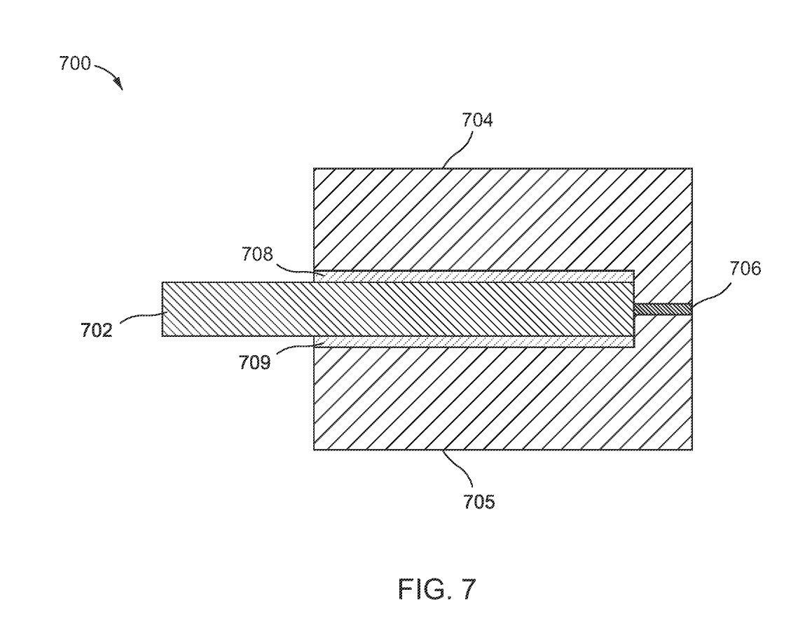

FIG. 7 illustrates a cross-sectional view of a two-piece node panel joint 700 according to an embodiment. Unlike the node panel joints described above, the node panel joint 700 can have two distinct (separate) nodes 704 and 705. The two nodes 704 and 705 can serve as receivers forming a socket for a panel 702. The node panel joint 700 can be bonded using film foam adhesives placed at interface location 708 between panel 702 and node 704, at interface location 709 between panel 702 and node 705, and at interface location 706 between nodes 704 and 705.

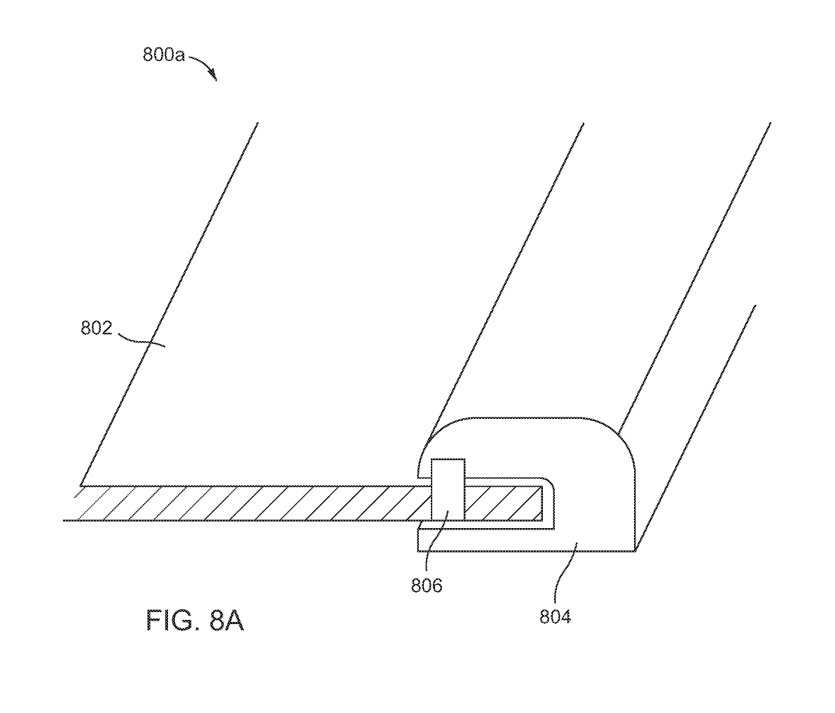

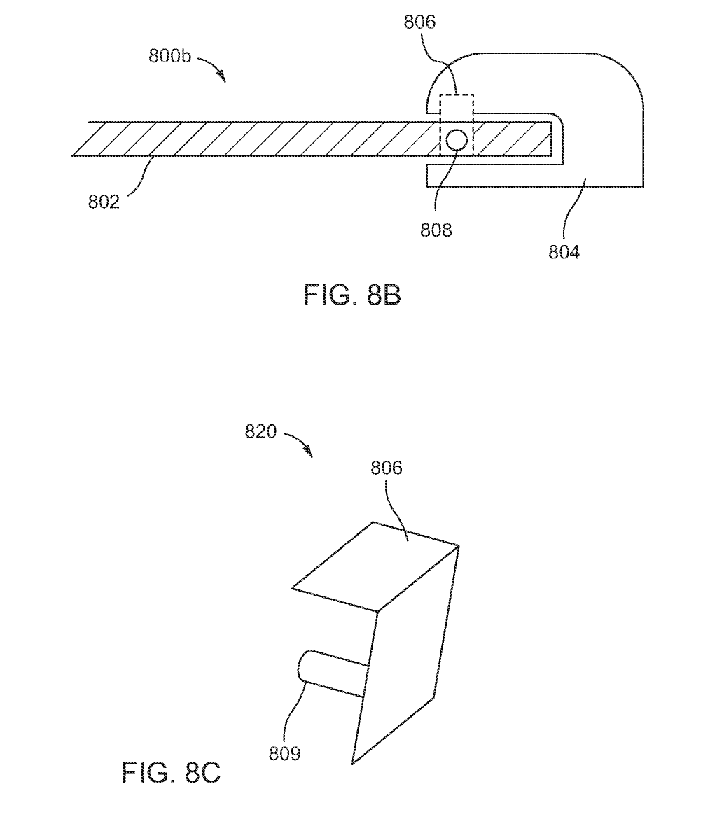

FIG. 8A illustrates a side perspective view of a panel node joint 800a using a clamp 806 according to an embodiment. The clamp 806 can be used to secure a panel 802 with a node 804. The clamp 806 can be a segment extending from the node 804 and having a protrusion (not shown in FIG. 8A) which inserts into a hole (not shown in FIG. 8A) within the side of the panel 802.

Prior to assembly, a hole can be drilled on the panel 802. A clamping feature, clamp 806, can be printed with the node, such that it goes through the hole (not shown in FIG. 8A). This hole can be at the end of the panel, thereby serving as a locating feature as well. A film foam adhesive can be applied along the interfacing surfaces between the panel 802 and node 804. In some embodiments, a clamping feature, similar to clamp 806, can also be placed at another end at the other surface of the node 804, or alternatively, at a backing plate or an extrusion. As one of ordinary skill in the art can appreciate upon review of this disclosure, placing clamps can be customized to certain locations on nodes, extrusions, and/or panels depending on geometry and surface features.

FIG. 8B illustrates a cross section view 800b of the panel node joint 800a of the embodiment of FIG. 8A. FIG. 8B depicts shows a hole 808 drilled or formed into the panel 804. The clamp 806, depicted as an outline above the panel hole 808, can have a protrusion (shown in FIG. 8C) which is inserted into the hole 808.

FIG. 8C illustrates a side perspective view 800c of the clamp 806 for use with the embodiment of FIG. 8A. The clamp 806 can have a protrusion 809 which is designed to fit into the hole 808 of FIG. 8B. The clamp 806 with protrusion 809 can, in one embodiment, be additively manufactured prior to assembly.

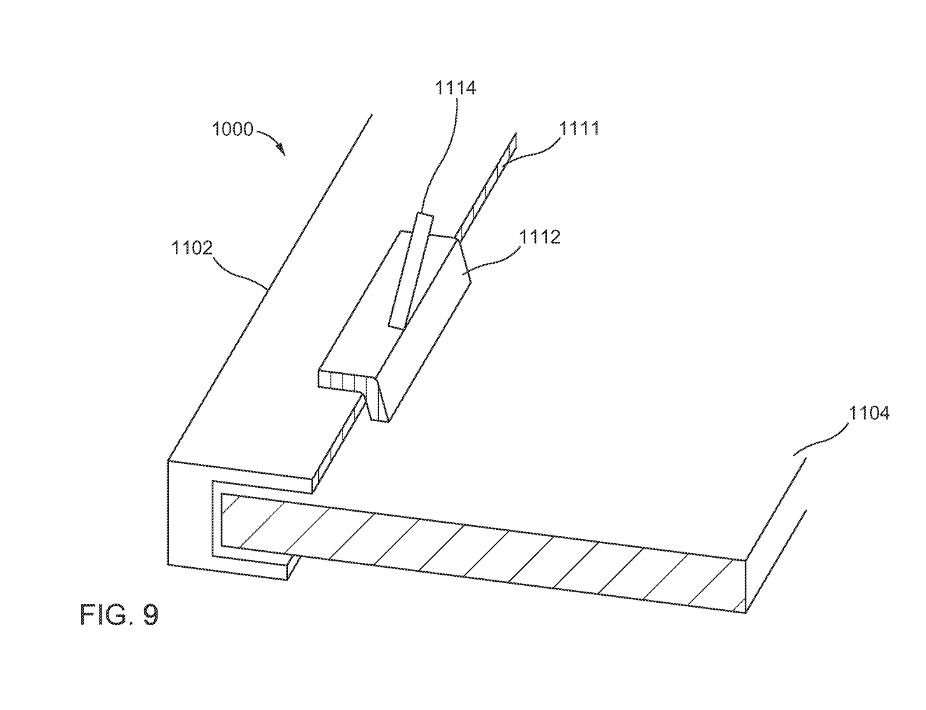

FIG. 9 illustrates a side perspective view of a panel node joint 1100 using a modular injector 1112 according to an embodiment. The panel node joint 1100 has node 1102 joined with a panel 1104. The modular injector 1112 can be additively manufactured with the node 1102 and can connect to the node side edge 1111. Using a position adjustment lever 1114, the modular injector 1112 can be selectively positioned to apply adhesive at select locations along the node 1102 and panel 1104 interfaces.

The modular injector 1112 advantageously allows for adhesive to be selectively injected into different regions and/or certain pockets along the node 1102 and panel 1104 interface. The modular injector 1112 can also be configured to provide a seal at the location of liquid adhesive flow.

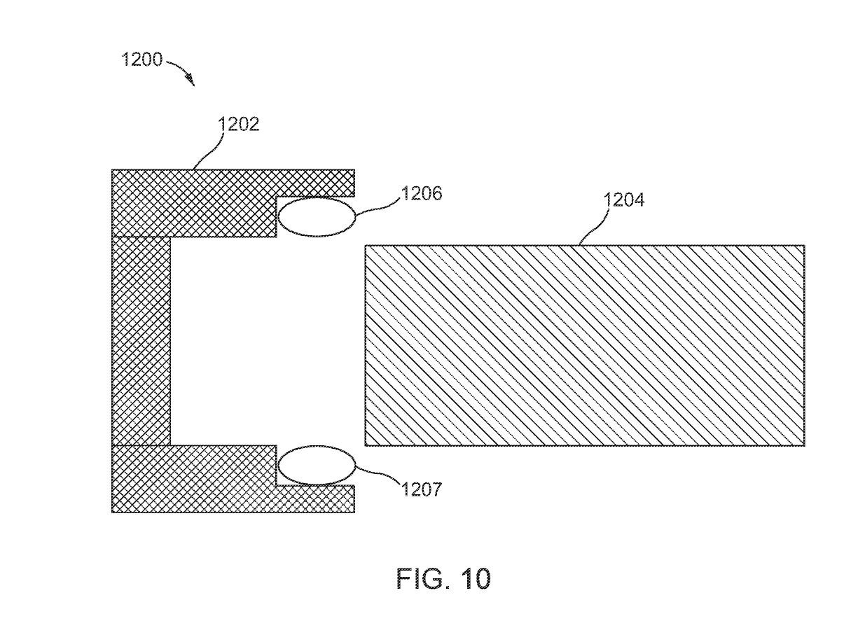

FIG. 10 illustrates a cross-section view of a panel node joint 1200 using adhesive tubes 1206-1207 according to an embodiment. Adhesive can be encapsulated inside the adhesive tubes 1206-1207 which in this embodiment run along the length of the connection interface in between the node 1202 and panel 1204. When the panel 1204 is inserted into the node 1202, the tubes 1206 and 1207 can break or shear during insertion. This can cause the tube to shear like a blister packet, causing it to release an adhesive at the interfaces. Although FIG. 10 shows an embodiment for using adhesive tubes 1206-1207 with a node 1202, adhesive tubes can also be used in extrusion panel joints.

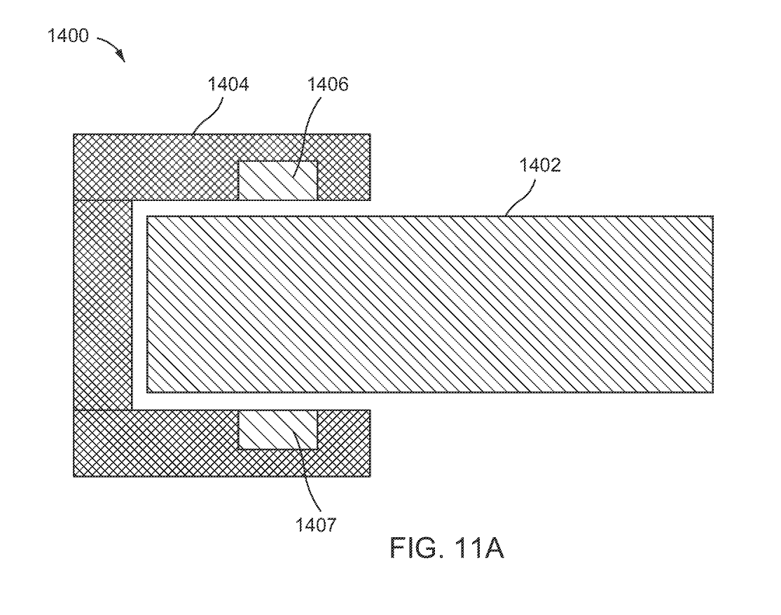

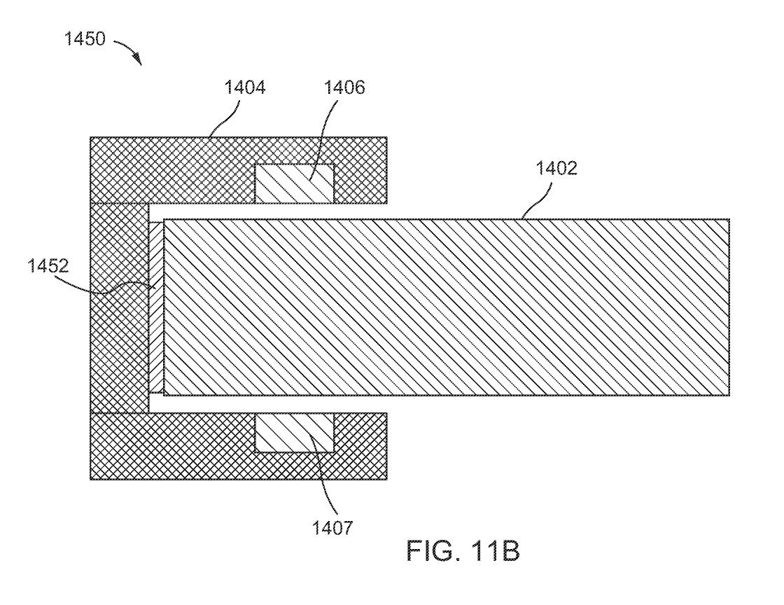

FIG. 11A illustrates a cross-section view of a panel node joint 1400 using a film foaming adhesive according to an embodiment. A panel 1402 is joined with a node 1404 using film foam adhesive applied along pockets (and/or grooves) 1406 and 1407 inside the node 1404. This configuration can be used without the need for sealant and can be used in side mount configurations. The panel 1402 can be inserted into the node 1404, and the assembly (joint 1400) can be put into an oven. An elevated temperature can cause the adhesive to foam and allow it to fill an interface, thereby creating a bond between the node 1404 and the panel 1402.

FIG. 11B illustrates a cross-section view of a panel node joint 1450 using a film foaming adhesive according to another embodiment. The panel node joint 1450 is similar to the panel node joint 1400 of FIG. 11A, except that a spacer 1452 is inserted between the node 1404 and the panel 1402. The spacer 1462 can advantageously separate the node 1404 from the panel 1402 to prevent one or more surfaces of the node 1404 from contacting one or more surfaces of the panel 1402. By preventing surfaces of the node 1404 from contacting surfaces of the panel 1402, the spacer can prevent galvanic corrosion.

Although FIG. 11B shows an embodiment of the panel node joint 1450 having a single spacer 1452, other configurations are possible. For instance, a plurality of spacers can be inserted between the node 1404 and the panel 1402 at different locations; and the spacers, also referred to as spacer structures, can be configured to meet any design requirements of the panel node joint 1450. For example, spacer structures can create a variety of separation distances between surfaces. In various embodiments, spacer structures can create larger separation distances between surfaces in order to reduce or prevent a reaction. A larger separation distance may be helpful to reduce or prevent galvanic corrosion, particularly between surfaces that have different electrode potentials. Spacer structures can be made of a variety of materials, such as rubber, adhesive, plastic, metal, and the like. The material composition of a spacer structure can be designed to provide a particular benefit, such as providing flexibility of movement between surfaces, providing rigidity to reduce or prevent movement, making the surfaces resistant or waterproof, making the surfaces resistant to other substances, such as oil, grease, dirt, and the like. In various embodiments, the structural design and material composition of the spacer structure can provide a crush zone allowing a portion of crash energy to be dissipated in a controlled manner.

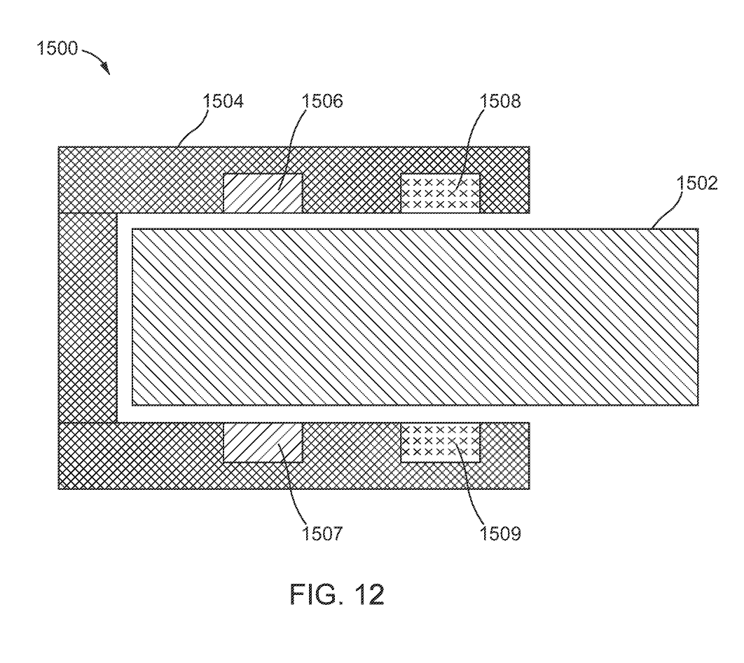

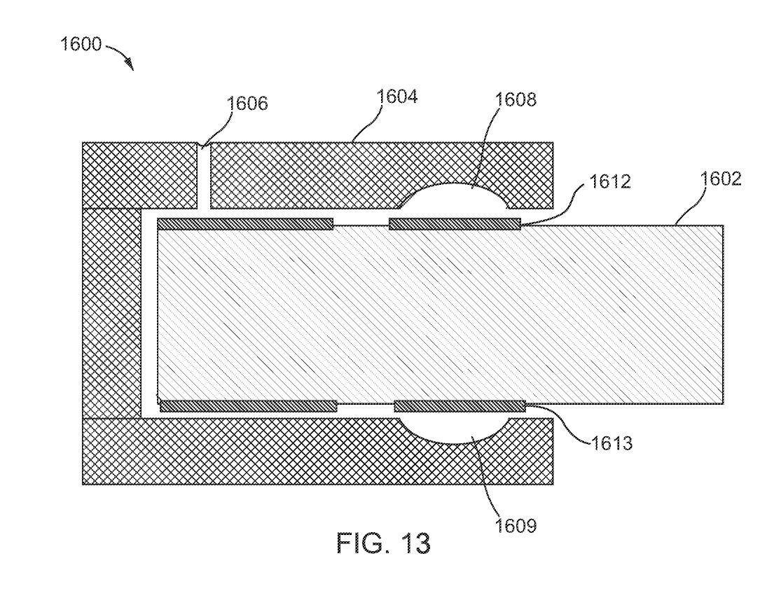

FIG. 12 illustrates a cross-section view of a side-mount panel node joint 1500 according to an embodiment. A node 1504 can be printed with adhesive cups or cavities 1506-1507 and sealant cups or cavities 1508-1509. In this embodiment, sealant and adhesive can be applied to the node 1504 prior to assembly. The panel 1502 can be inserted into the node 1504 and temperature can be increased to cure the adhesive.

FIG. 13 illustrates a cross-section view of an end-mount panel node joint 1600 according to an embodiment. Unlike the approach of FIG. 12, sealant and adhesive may be applied to a panel 1602 prior to assembly. The sealant can be applied at locations 1612-1613, and the adhesive can be applied at locations 1610-1611. Additionally, a weep hole 1606 can be printed with or in the node 1604. The weep hole 1606 can be used to monitor adhesive flow. A condition where adhesive flows out of the weep hole 1606 may indicate completion of the adhesive filling process. Sealant cups 1608-1609 and adhesive cups (not shown) can be provided in the node to facilitate the flow of excess glue to enhance the seal. After the panel 1602 is inserted into the node 1604, the temperature can be increased to drive the sealing and adhesion process.

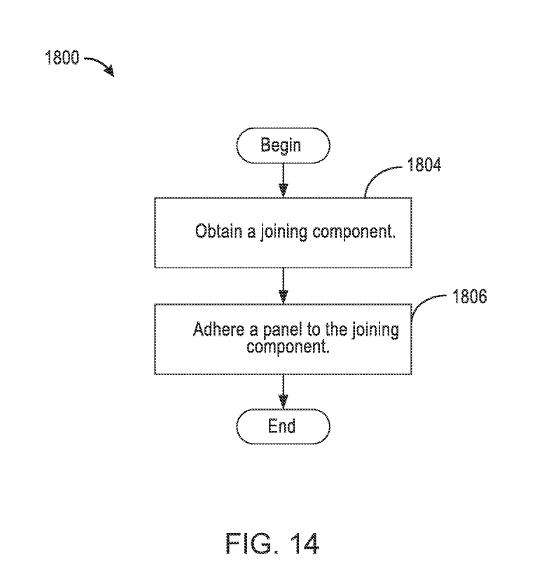

FIG. 14 conceptually illustrates a process 1800 for joining a panel with a joining component. The process 1800 includes process steps 1804 and 1806. Process step 1804 relates to obtaining a j oining component such as a node or extrusion. The joining component can comprise a node and/or an extrusion as described in the embodiments herein. The next step 1806, adhere a panel to the joining component, can also be accomplished using embodiments discussed herein; and as indicated above, a panel can be a COTS panel or an additively manufactured panel having honeycomb, foam, or other performance enhancing structures or materials therein.

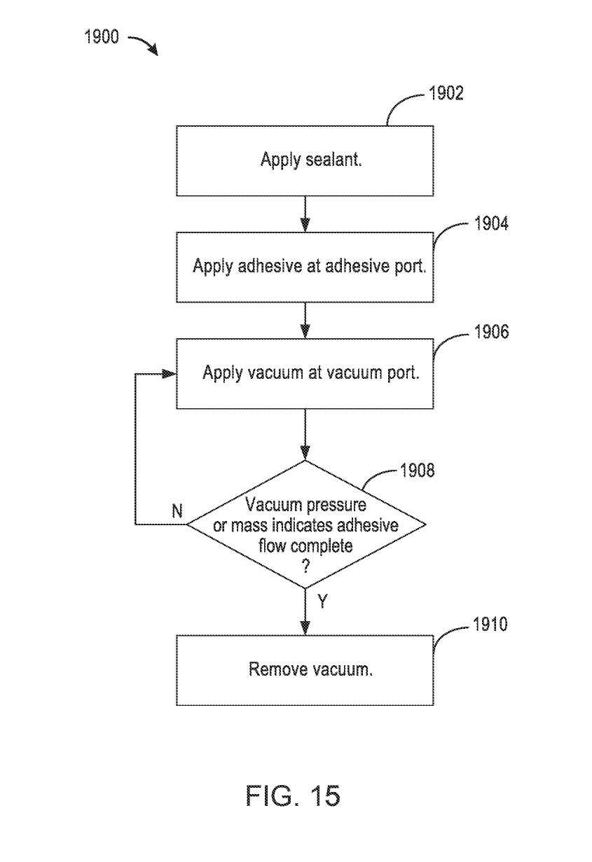

FIG. 15 conceptually illustrates an adhesion process 1900 for joining a panel with the joining component according to an embodiment. The adhesion process can be a sequence or subsequence for accomplishing step 1806 of process 1800. The process 1900 of FIG. 15 can be a liquid adhesive process as applied to embodiments using liquid adhesives with sealants and vacuums. In step 1902 a sealant is first applied to secure a panel, such as panel 202, with a node, such as node 204 of FIG. 2. Next, the process step 1904 indicates applying an adhesive at an adhesive channel adhesive port and then step 1906 indicates applying a vacuum at a channel vacuum port. In some embodiments, step 1904 can be performed after step 1906. Following and during steps 1904 and 1906, the vacuum can draw the adhesive into a panel node/extrusion interface. In decision step 1908, the vacuum pressure and the mass can be monitored until the pressure or mass indicates that adhesive substantially fills the interface. On completion of the adhesive application, the vacuum is removed in step 1910; at this point the adhesive can cure, thereby forming a joint between the a node/extrusion and panel.

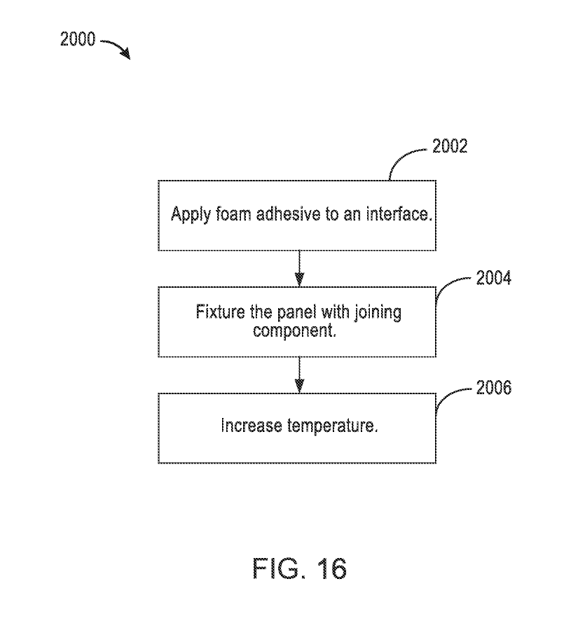

FIG. 16 conceptually illustrates an adhesion process 2000 for joining a panel with the joining component according to another embodiment. As in the process 1900 of FIG. 15, the adhesion process 2000 can be a sequence or subsequence for accomplishing step 1806 of process 1800. The process 2000 of FIG. 16 can be a film foam adhesive process as applied to embodiments, including the embodiment of j oint 300 of FIG. 3. In step 2002 a film foam adhesive can be applied to an interface of a panel with a node/extrusion interface. Thereupon, in step 2004, the panel can be fixtured with the joining component. Then, in step 2006 the temperature can be increased so as to cure the film foam adhesive bond between the node/extrusion and panel.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing and joining panels, nodes, and/or extrusions with various interconnects (interconnect units). Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
a component having a socket;
a panel having an end portion positioned within the socket; and
an adhesive between the end portion of the panel and the socket to adhere the panel to the component.

2. The apparatus of claim 1, wherein the panel is additively manufactured.

3. The apparatus of claim 1, wherein the component comprises a channel extending from an external surface of the component to the socket for adhesive injection.

4. The apparatus of claim 3, wherein the component further comprises a second channel extending from an external surface of the component to the socket for applying a vacuum during adhesive injection.

5. The apparatus of claim 1, further comprising a sealant between the end portion of the panel and the socket to seal the adhesive in the socket.

6. The apparatus of claim 5, wherein the sealant between the end portion of the panel and the socket reduces galvanic corrosion by forming a gap.

7. The apparatus of claim 1, further comprising a spacer between the end portion of the panel and the socket, the spacer separating a surface of the panel from a surface of the socket.

8. The apparatus of claim 7, wherein the surface of the panel is separated from the surface of the socket so as to reduce galvanic corrosion.

9. The apparatus of claim 1, wherein the panel comprises a plurality of adhesive patches extending across an edge of the end portion of the panel, the adhesive between the end portion of the panel and the socket extending from the adhesive patches.

10. The apparatus of claim 9, wherein the component comprises an additively manufactured node having one or more co-printed heat conductors thermally coupled to the adhesive patches.

11. The apparatus of claim 1, further comprising a node having a second socket at one end and a channel extending from the second socket to an opposite end of the node, wherein the component comprises an extrusion located in the second socket, and wherein the panel extends from the socket in the extrusion through the channel in the node.

12. The apparatus of claim 11, wherein a first portion of the adhesive is in the channel between the node and the panel, a second portion of the adhesive is in the socket between the extrusion and the panel, and a third portion of the adhesive is in the second socket between the extrusion and the node.

13. The apparatus of claim 12, further comprising a plurality of sealants arranged to seal the first, second and third portions of the adhesive from one another.

14. The apparatus of claim 1, wherein the component comprises two nodes adhered together to form the socket.

15. The apparatus of claim 1, wherein the panel comprises a hole, and wherein the component comprises a protrusion extending into the hole of the panel.

16. The apparatus of claim 1, wherein the component comprises an additively manufactured node having one or more co-printed grooves in the socket.

17. The apparatus of claim 16, wherein the one or more grooves comprises a first groove and a second groove, wherein the first groove and the second groove form a channel, and wherein the channel is configured to from a seal upon receiving an adhesive injection.

18. The apparatus of claim 1, wherein the component comprises an additively manufactured node having a plurality of weep holes.

19. The apparatus of claim 18, wherein the plurality of weep holes are for visually monitoring adhesive flow.

20. The apparatus of claim 18, wherein the plurality of weep holes are configured to allow adhesive flow unassisted by a vacuum or sealant.

21. The apparatus of claim 1, wherein the component comprises an additively manufactured node having a plurality of ports for air expulsion during adhesive injection.

22. The apparatus of claim 1, wherein the panel includes one or more thermocouples.

23. The apparatus of claim 1, further comprising an additively manufactured modular injector for adhesive injection in a selected region between the component and the panel, the modular injector further comprising a portion that seals the adhesive between the component and panel in the selected region.

24. The apparatus of claim 1, further comprising a punctured encapsulated adhesive tube located on an internal surface of the socket, the adhesive extending from the punctured tube into the socket.

25. The apparatus of claim 1, wherein the internal surface of the socket includes a notch, the punctured encapsulated adhesive tube being located in the notch.

26. The apparatus of claim 1, wherein the panel comprises a hole, and wherein the component comprises an additively manufactured node having a co-printed pin extending through the hole.

27. The apparatus of claim 25, further comprising a cap having a hole, wherein the distal end of the pin extends through the hole to secure the panel between the node and the cap.

28. The apparatus of claim 1, wherein the component further comprises an additively manufactured node having one or more grooves formed in the socket, the adhesive extending from the one or more grooves into the socket.

29. The apparatus of claim 27, wherein the end portion of the panel comprises a surface adjacent to the one or more grooves.

30. The apparatus of claim 27, wherein the end portion of the panel comprises first and second surfaces wherein:
the first and second surfaces comprise a core region between the first and second surfaces; and
the one or more grooves includes a groove positioned along the core at an edge of the end portion of the panel.

31. The apparatus of claim 1, wherein the component comprises an additively manufactured node having a hole extending from the surface of the node to the socket to visually monitor adhesive flow.

32. The apparatus of claim 1, wherein the component comprises an additively manufactured node having one or more cups formed in the socket for adhesive or sealant overflow.

33. A method of joining a panel of a transport vehicle, the method comprising:
obtaining a joining component, the joining component comprising a node; and
adhering the panel to the joining component.

34. The method of claim 33, wherein the adhering the panel to the joining component comprises:
applying a film foam adhesive to an interface of the panel and the joining component;
fixturing a joint between the panel and the joining component; and
increasing the temperature of the adhesive so as to create an adhesive bond.

35. The method of claim 33, wherein the joining component further comprises an extrusion.

36. The method of claim 33, wherein the panel is additively manufactured.

37. The method of claim 33, wherein the node is additively manufactured.

38. The method of claim 33, wherein adhering the panel to the joining component further comprises:
inserting a spacer between the panel and the joining component, the spacer forming a gap between a surface of the panel and a surface of the joining component.

39. The method of claim 38, wherein the spacer forms the gap between the surface of the panel and the surface of the joining component so as to reduce galvanic corrosion.

40. The method of claim 33, wherein adhering the panel to the joining component further comprises:
applying a sealant so as to secure the panel with the joining component;
injecting an adhesive into an interface of the panel and the joining component.

41. The method of claim 40, wherein the sealant reduces galvanic corrosion by forming a gap.

42. The method of claim 40, wherein injecting an adhesive into an interface of the panel and the joining component comprises:
applying an adhesive via an adhesive port; and
providing a vacuum via a vacuum port.

43. The method of claim 42 further comprising:
monitoring a pressure of the vacuum, the pressure indicative of the amount of adhesive drawn into the interface; and
withdrawing the vacuum when the pressure indicates the adhesive substantially fills the interface.

44. The method of claim 42, wherein applying an adhesive via an adhesive port occurs after providing a vacuum via a vacuum port.

45. The method of claim 42, wherein applying an adhesive via an adhesive port occurs before providing a vacuum via a vacuum port.
